(19) United States
(12) Patent Application Publication
(10) Pub. No.: US 2026/0238577 A1
(43) Pub. Date: Aug. 13, 2026

(54) SYNCHRONIZED CONTENT OUTPUT ACROSS MULTIPLE DEVICES

(71) Applicant: Comcast Cable Communications, LLC, Philadelphia, PA (US)

(72) Inventors: Alexander Giladi, Centennial, CO (US); Johnathon Benton, Evergreen, CO (US)

(21) Appl. No.: 19/536,467

(22) Filed: Feb. 11, 2026

Related U.S. Application Data
(60) Provisional application No. 63/757,101, filed on Feb. 11, 2025.

(51) Int. Cl. H04L 43/0852; H04L 43/16; H04L 65/80

(52) U.S. Cl. CPC H04L 43/0852; H04L 43/16; H04L 65/80

(57) ABSTRACT

The present disclosure provides a method for synchronizing content output across multiple output devices. A first computing device may receive information associated with output of content by a plurality of output devices. The first computing device may determine a target latency for the plurality of output devices based on the received information by assigning the plurality of output devices into at least two latency groups based on the information associated with output of content associated with each output device and determining a target latency for each latency group. The first computing device may transmit, to at least one output device of the plurality of output devices, an indication of the target latency corresponding to the latency group of the at least one output device. The first computing device may cause the at least one output device to adjust an output speed of the content.

### CROSS-REFERENCE TO RELATED APPLICATIONS

This application is Nonprovisional of and claims the benefit of Provisional Application Serial No. 63/757,101, filed February 11, 2025, which is hereby incorporated by reference in its entirety for any and all purposes.

### BACKGROUND

In environments such as sports bars, viewers often expect to see the same content simultaneously on multiple screens. A similar expectation exists with synchronization between audio and video, where even slight misalignments can be noticeable.

Improvements are needed.

### SUMMARY

It is to be understood that both the following general description and the following detailed description are exemplary and explanatory only and are not restrictive. Methods and systems for synchronizing content output across multiple devices are described.

The present disclosure provides methods for grouping output devices into latency groups and coordinating content output timing using group-specific target latencies. Methods may include receiving, by a first computing device, information associated with output of content by a plurality of output devices (which may include a plurality of first output devices and a plurality of second output devices), assigning the plurality of first output devices into a first latency group and the plurality of second output devices into a second latency group based on the information, and determining a target latency for each latency group. The first computing device may transmit, to at least one output device of the plurality of output devices, an indication of the target latency corresponding to a latency group of the at least one output device, and may cause, based on the indication of the target latency, the at least one output device to adjust an output speed of the content by modifying a rendering time of one or more individual frames of the content.

The present disclosure provides methods for separately evaluating output behavior of multiple output devices, associating the devices with different latency groups, and issuing corresponding target latencies to drive output speed adjustment. Methods may include receiving, by a first computing device, first information associated with output of content by a first output device and receiving, by the first computing device, second information associated with output of the content by a second output device, determining, based on the first information, that the first output device is associated with a first latency group, and determining, based on the second information, that the second output device is associated with a second latency group. The first computing device may transmit an indication of a first target latency associated with the first latency group to the first output device and may transmit an indication of a second target latency associated with the second latency group to the second output device, and may cause, based on at least one of the indication of the first target latency or the indication of the second target latency, at least one of the first output device or the second output device to adjust an output speed of the content by modifying a rendering time of one or more individual frames of the content.

The present disclosure provides methods for output-device-side adjustment of content output speed based on a target latency received from another computing device. Methods may include transmitting, from an output device, information associated with output of content to a first computing device and receiving, at the output device, an indication of a target latency. The output device may then adjust an output speed of the content based on the target latency by modifying a rendering time of one or more individual frames of the content.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example synchronization system described herein.

FIG. 2 shows a distribution system for synchronized content output.

FIG. 3 shows a method for synchronizing content output across multiple output devices described herein.

FIG. 4 shows a method for synchronizing content output across multiple output devices described herein.

FIG. 5 shows a method for synchronizing content output across multiple output devices described herein.

The accompanying drawings show examples of the disclosure. It is to be understood that the examples shown in the drawings and/or discussed herein are non-exclusive and that there are other examples of how the disclosure may be practiced.

### DETAILED DESCRIPTION

The systems and methods described herein relate to content delivery and synchronizing presentation of video content on multiple screens. Output speeds may be adjusted so as to move a latency target on a number of screens to prevent latency from hindering a viewing experience. A time difference between a system clock and a presentation clock may be set based on a group of parameters. The parameters may be included in information received from multiple screens and/or devices associated with the multiple screens. Content delivery may be synchronized across the multiple screens based on the set time difference.

The present disclosure relates to systems and methods for synchronizing content output across multiple devices. In various implementations, the systems and methods may provide tightly synchronized presentation of video content on multiple screens, which may be beneficial for a range of applications.

The synchronization may be achieved within a specific time range, such as between -125 milliseconds and +45 milliseconds. Such a level of synchronization may be particularly useful in environments where multiple viewers are watching the same content on different screens, especially live, low-latency events, such as live sporting events in sports bars or similar venues. The tight synchronization may allow viewers to experience a cohesive viewing experience across all screens, with minimal perceptible differences in timing. Additionally, audio presented may appear synced with any screen in range of the audio.

The systems and methods described herein may be applicable to various use cases beyond sports bars. For example, the synchronization techniques may be employed in sports betting scenarios, where it may be important for all participants to view events simultaneously to ensure fair betting conditions. Additionally, the systems and methods may be utilized in watch parties, where multiple viewers in different locations may desire a shared, synchronized viewing experience.

The synchronization techniques may be applied to conference and in-venue screens, allowing for coordinated display of content across multiple screens in large spaces. Furthermore, the systems and methods may enhance secondary screen experiences, where supplementary content on additional devices may be precisely timed with the main content.

The synchronization approach described herein may involve adjusting output speeds to achieve a target latency across multiple devices. The systems and methods described herein may allow for dynamic adaptation to varying network conditions and device capabilities, while maintaining a consistent viewing experience for users across different screens or locations.

By providing flexible and adaptive synchronization capabilities, the systems and methods of the present disclosure may offer improved viewing experiences across a wide range of applications where coordinated content presentation is desired.

In an illustrative example, a controller (computing device, etc.) receives information on (a) current live latency of a client, (b) a combination of the wall clock time, arrival time, media/content decoding time, and the time the segment became available at the origin for the current segments, (c) the current rebuffering rate and optionally additional data such as output rate, statistics of the observed network connection and its stability, and the CDN and CDN edge used. This information is provided for both audio and video. This information can be transmitted in HTTP headers or query parameters on existing requests (e.g., such as manifest requests) or be within headers, body, or URL of a standalone server connected to the controller. Other data and systems may be used.

The controller may execute (or cause execution of) a processing algorithm (which may range from a simple or harmonic averaging to more complex statistical signal processing techniques) estimating the latency sufficient to maintain some X% of the clients within the selected latency “bin” (e.g. -125ms..+45ms). The algorithm may be configured to exclude outliers that are far enough from the estimate, which may be defined as a target latency. As an example, the controller may segment the clients into a “low-latency” and “normal” and/or “reduced” latency bins and assign different classes of latency to different clients. This can be based on the health of individual clients, or/and knowledge about network topology and link status for links and termination equipment used, such as but not limited to CMTS in cable systems. In this case the latency target will be such that some large majority of clients (some N%) will be expected to make sure the clients within each bin will have better predicted health (e.g. least rebuffering rate). When a client is evicted from a low-latency cohort it is useful to let it know that it is being switched to a "normal" latency experience due to network connectivity issues.

The controller may determine a separate target latency for each of the latency groups, such that different client devices may be associated with different target latencies based on their assigned latency group.

The estimated latency target may be communicated to clients within the latency bin or group. This communication can be done in headers of the responses to the clients (such as requests for manifests, for content steering). The clients will then adjust their latency by small changes to the individual frame rendering times sufficient to reach the target speed within a given time (e.g., 2-4s). In another embodiment the server will not change the latency recommendation for clients close enough to the target latency in order to minimize the number of times output speed modulation is needed.

A client device (e.g., output device) associated with a latency group may compare a current measured latency (e.g., an end-to-end live latency measured relative to a wall clock and/or a presentation clock) to a target latency indicated for the latency group, determine a latency error (e.g., a difference between the current measured latency and the target latency), and adjust an output speed of the content to reduce the latency error and thereby conform output of the client device to the latency group.

For example, a first client device assigned to a low-latency group may receive an indication of a target latency of 3.0 seconds behind live content and may determine that the first client device is currently outputting the content at a measured latency of 3.3 seconds (i.e., 300 milliseconds behind the target latency). In response, the first client device may temporarily increase an output speed of the content (e.g., by decreasing frame durations and/or otherwise increasing a rendering rate) to reduce the measured latency toward the target latency. As an illustrative, non-limiting example, the first client device may increase the output speed by about 1% to about 5% (e.g., about 1.03× nominal speed) for a time interval sufficient to reduce the latency error (e.g., until the measured latency is within a threshold of the target latency for the latency group). The threshold may correspond to a tolerance band of the latency group (also referred to as a latency “bin”), such as a range, for example, of about −125 milliseconds to about +45 milliseconds relative to the target latency. After the measured latency is within the threshold, the first client device may return the output speed to a nominal output speed and/or may maintain output speed adjustments within a bounded range to track subsequent target latency updates.

As another example, a second client device assigned to the same latency group may receive the indication of the target latency of 3.0 seconds and may determine that the second client device is currently outputting the content at a measured latency of 2.7 seconds (i.e., 300 milliseconds ahead of the target latency). In response, the second client device may temporarily decrease the output speed of the content (e.g., by increasing frame durations, reducing a rendering rate, and/or inserting one or more controlled micro-pauses or frame holds) to increase the measured latency toward the target latency. As an illustrative, non-limiting example, the second client device may decrease the output speed by about 1% to about 5% (e.g., about 0.97× nominal speed) for a time interval sufficient to reduce the latency error (e.g., until the measured latency is within a threshold of the target latency for the latency group). The threshold may correspond to the tolerance band (latency “bin”) for the latency group, such as about −125 milliseconds to about +45 milliseconds relative to the target latency. After the measured latency is within the threshold, the second client device may return the output speed to a nominal output speed and/or may maintain output speed adjustments within a bounded range to track subsequent target latency updates, while optionally maintaining audio pitch and/or audio-video synchronization during the adjustment.

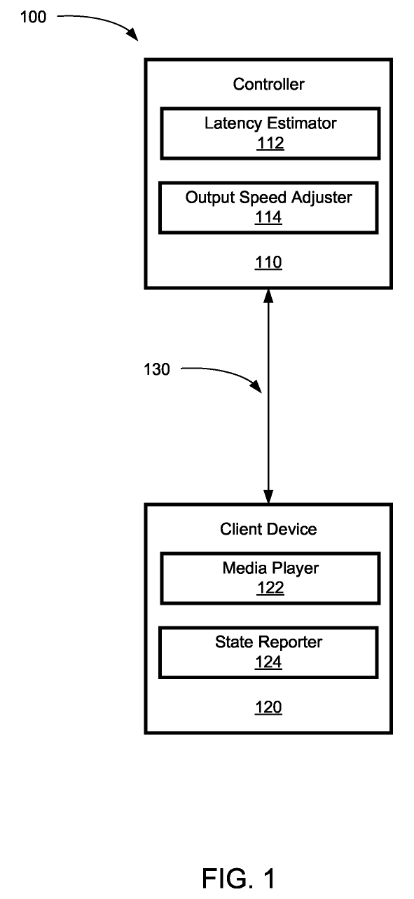

FIG. 1 illustrates a block diagram of a synchronization system 100 for coordinating content output (playback, etc.) across multiple devices. The synchronization system 100 may include a controller 110 and a client device 120 connected via a communication link 130. Although shown as a direct link between the controller 110 and the client device 120 in FIG. 1, the communication link 130 may comprise multiple intervening devices, such as network. References to controller and client device are illustrative and are not intended to be limiting to the hardware, logic, or functional implementation. Other computing devices may be configured to implement the methods described herein.

The controller 110 may be one or more computing device(s) comprising a latency estimator 112 and an output speed adjuster 114. The latency estimator 112 may connect to the output speed adjuster 114 through an internal connection, allowing for data flow between the components.

The controller 110 may receive various types of information from the client device 120. The information may include current live latency, wall clock time (real-time, elapsed real time, wall time, etc.), arrival time, media/content decoding time, and the time a segment became available at the origin for the current segments. The controller 110 may receive data on the current rebuffering rate, output rate, raw data and/or descriptive statistics (variance, quartiles, etc.) of the observed network connection (including statistics regarding network stability), and information about the Content Delivery Network (CDN) and CDN edge used. The information may be provided for both audio and video content.

The latency estimator 112 within the controller 110 may use various processing algorithms to estimate latency. The processing algorithms may range from simple or harmonic averaging to more complex statistical signal processing techniques. The latency estimator 112 may exclude outliers that are far enough from the estimate to determine a target latency.

The output speed adjuster 114 may use the estimated target latency to communicate adjustments to the client device 120. The output speed adjuster 114 may not change the latency recommendation for client devices 120 that are close enough to the target latency. The number of times output speed modulation is needed may be lessened.

The client device (e.g., display device, user device, output device) 120 may comprise a content/media player 122 and a state reporter 124. The media player 122 may connect to the state reporter 124 through an internal connection. The state reporter 124 may communicate with the controller 110, providing information about the client device's output state.

The media player 122 may be responsible for rendering the audio and video content on the client device 120. The state reporter 124 may collect and transmit the various types of information required by the controller 110 for latency estimation and output speed adjustment.

In operation, the synchronization system 100 may function as follows: The state reporter 124 in the client device 120 may continuously gather data about the current output state, network conditions, and timing information. The data may be sent to the controller 110. The latency estimator 112 in the controller 110 may process the information using to determine a target latency. The output speed adjuster 114 may then communicate the target latency back to the client device 120.

Upon receiving the target latency, the media player 122 in the client device 120 may adjust output by making small changes to individual frame rendering times. The adjustments may be designed to reach the target speed within a given time frame, such as 2-4 seconds. By making small, gradual adjustments, the synchronization system 100 may maintain a smooth viewing experience while achieving synchronization across multiple devices.

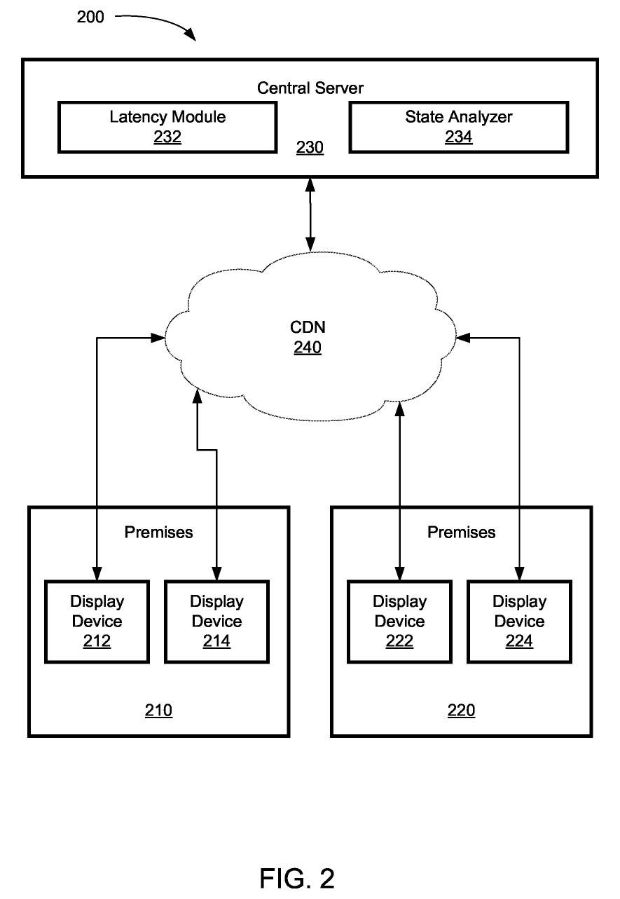

FIG. 2 illustrates a distribution system 200 for synchronized content output. The distribution system 200 may include a first premises 210, a second premises 220, a central server 230, and a content delivery (distribution) network (CDN) 240. The first premises 210 may comprise a first display device 212 and a second display device 214. The second premises 220 may comprise a third display device 222 and a fourth display device 224. The central server 230 may comprise a latency module 232 and a state analyzer 234. The latency module 232 may process latency-related information, while the state analyzer 234 may monitor the status of connected devices, such as the display devices 212, 214, 222, and 224 and devices in the CDN 240. The CDN 240 may facilitate content delivery (distribution, deployment, etc.) to the display devices 212, 214, 222, and 224.

The first premises 210 and/or the second premises 220 may comprise a venue for viewing a live event on multiple screens, such as a sports bar, casino, election watch party, etc. The first display device 212, the second display device 214, the third display device 222, and/or the fourth display device 224 may comprise a media/content player, screen, laptop, mobile device, television, projector, etc. The first display device 212, the second display device 214, the third display device 222, and/or the fourth display device 224 may be and/or comprise the client device 120 in FIG. 1.

The central server 230 may be and/or comprise the controller 110 in FIG. 1. The central server 230 may segment client devices based on location. Users observing display devices 212 and 214 at the first premises 210 may benefit from a common latency across display devices. The latency module 232 may determine (calculate, etc.) a latency associated with the first display device 212 and the second display device 214. If one of the first display device 212 and the second display device 214 is determined to have a higher latency, then the central server 230 may cause the higher latency to be a target latency for each display device associated with first premises 210. The central server 230 may perform a similar process for display devices at other premises, such as the display devices 222 and 224 at the second premises 220.

The central server 230 may segment display devices into different latency groups. The central server 230 may categorize display devices into low-latency and normal latency bins. The central server 230 may categorize display devices based on various factors such as client health or network topology. The client health may be determined by analyzing data such as rebuffering rates, output stability, or network connection quality. Network topology considerations may include factors like link utilization, bandwidth availability, network stability, or a specific content delivery network (CDN) edge or link being used.

The latency module 232 may determine target latencies for each latency group. Display devices in the low-latency bin may receive a lower target latency, while display devices in the normal latency bin may receive a higher target latency. The distribution system 200 may accommodate display devices with varying capabilities and network conditions.

In operation, the distribution system 200 may function as follows: The display devices 212, 214, 222, and 224 may continuously send output and network information to the central server 230 through the CDN 240. The state analyzer 234 may process information received from the display devices 212, 214, 222, and 224 to determine a current state and capability of each device. Based on the information processed, the latency module 232 may assign each display device 212, 214, 222, and 224 to a latency group and determine appropriate target latencies. The central server 230 may transmit the target latencies back to the respective devices 212, 214, 222, and 224 through the CDN 240. Upon receiving the target latencies, each display device 212, 214, 222, and 224 may adjust an associated output speed to achieve synchronization within an assigned latency group. The process described herein may be repeated periodically to maintain synchronization as network conditions and device states change over time.

By utilizing an adaptive approach, the distribution system 200 may achieve synchronized output across a diverse range of devices and network conditions, enhancing the viewing experience for multiple users accessing the same content simultaneously.

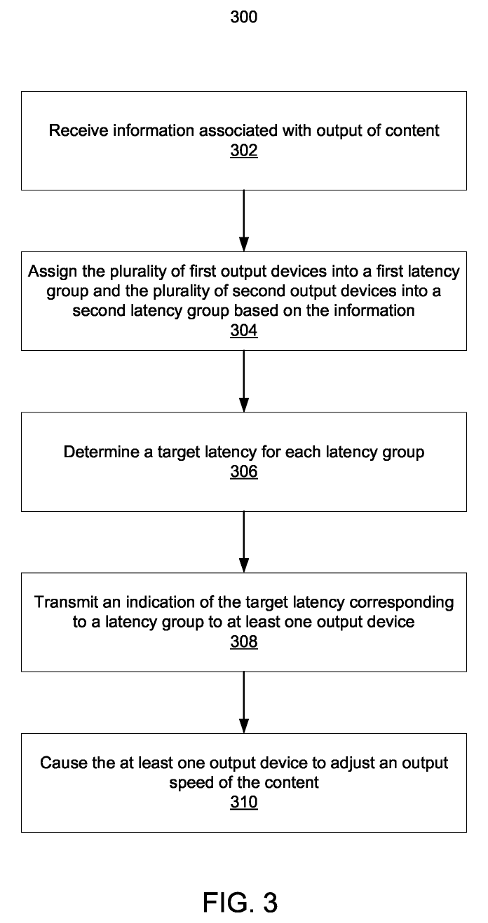

FIG. 3 illustrates a flowchart of a method 300 for synchronizing content output across multiple output devices. The method 300 may be performed by a computing device. The method 300 may be performed by the controller 110 in FIG. 1. The method 300 may be performed by the central server 230 in FIG. 2.

Information associated with output of content may be received (block 302). The information may be received by a first computing device. The first computing device may be the controller 110 in FIG. 1, or the central server 230 in FIG. 2, for example. The output of content may be by a plurality of output devices. The information associated with output of content may include a current live latency, a wall clock time, an arrival time, a media/content decoding time, a time a segment became available at an origin server, a current rebuffering rate, an output rate, statistics of an observed network connection, or information associated with a content delivery network (CDN). The content may comprise a live video stream. The plurality of output devices may comprise a plurality of first output devices and a plurality of second output devices.

The plurality of first output devices may be assigned into a first latency group and the plurality of second output devices may be assigned into a second latency group based on the information (block 304). The first computing device may assign the plurality of output devices into at least two latency groups based on the information. The information may comprise parameters associated with the plurality of output devices. The assigning the plurality of output devices into at least two latency groups may comprise analyzing network conditions associated with each output device and assigning each output device to a latency group based on the analyzed network conditions. The information may comprise network conditions, such as network bandwidth, network stability, or network latency. The information may comprise a health metric. The first computing device may determine the health metric for each output device based on the received information. The health metric may include factors such as a rebuffering rate, an output stability measure, or a network connection quality indicator.

The at least two latency groups may comprise a low-latency group and a normal-latency group. A output device may be reassigned from the low-latency group to the normal latency group based on a change in at least one parameter associated with the output device. The reassigned output device may be notified of a change from a low-latency group to a normal-latency group. The target latency for at least one of the latency groups may be periodically determined again (recalculated, etc.) based on updated information received from at least one output device associated with the latency group. The assigning the plurality of output devices into at least two latency groups may be performed separately for audio and video components of the content. The assigning the plurality of output devices into at least two latency groups may be performed for a video component of the content.

A target latency may be determined for each latency group (block 306). The first computing device may determine a target latency for each latency group. The determining the target latency for each latency group may comprise estimating a latency sufficient to maintain a predetermined percentage of output devices within each latency group within a selected latency range. A statistical processing technique may be applied to the information associated with output of content for output devices within each latency group. The statistical processing technique may include simple averaging, harmonic averaging, or more complex statistical signal processing techniques. The statistical processing technique may include complex statistical and machine learning (ML) based techniques, such as clustering. Information associated with output devices having latencies that differ from an estimated latency by more than a threshold amount may be excluded. The target latency for a latency group may be determined to prevent rebuffering event for output devices within the latency group. The determining the target latency for each latency group may be performed separately for audio and video components of the content. The determining the target latency for each latency group may be performed for a video component of the content.

An indication of the target latency corresponding to the latency group of at least one output device of the plurality of output devices may be transmitted to the at least one output device (block 308). The first computing device may transmit the indication of the target latency to the at least one output device. The indication of the target latency may be transmitted in a header of a response to a request from the at least one output device. The indication of the target latency may be transmitted in a message separate from a response to a request from the at least one output device. The transmitting the indication of the target latency may cause the at least one output device to modify a rendering time of individual frames of the content.

A determination may be made of whether to adjust the target latency corresponding to the latency group. The determination may be based on various factors, including changes in network conditions, feedback from output devices, or the passage of a certain amount of time.

If a determination has been made to adjust the target latency corresponding to the latency group, then the target latency corresponding to the latency group may be recalculated (determined again, etc.) based on updated information. Recalculating the target latency corresponding to the latency group may comprise reassigning at least one output device between latency groups based on changes in associated information (parameters, etc.). The target latency may be adjusted based on a predetermined latency range associated with human perception of audio-visual synchronization. The predetermined latency range may be between -125 milliseconds and +45 milliseconds. The recalculated target latency corresponding to the latency group may be transmitted to the at least one output device. Recalculating the target latency in the manner described allows for dynamic adjustment of the target latency during ongoing output, such as during a live video stream, based on changing network conditions.

The at least one output device may be caused to adjust an output speed of the content (block 310). The first computing device may cause the at least one output device to adjust the output speed of the content. The first computing device may cause the at least one output device to adjust the output speed of the content based on the indication of the target latency. The at least one output device may adjust the output speed of the content by modifying a rendering time of one or more individual frames of the content.

Changes in network topology affecting the plurality of output devices may be monitored. The assigning of output devices into latency groups may be adjusted based on the changes in network topology monitored. The target latency may be dynamically adjusted for each latency group during a live video stream based on changing network conditions. The at least one output device may apply the target latency. Feedback from the at least one output device regarding the applied target latency may be received. Subsequent target latency determinations (calculations, etc.) may be adjusted based on the received feedback.

A synchronization report detailing the performance of output devices in maintaining the target latency within associated latency groups may be generated. The synchronization report may include statistics on the percentage of output devices successfully maintaining synchronization within a predetermined threshold of an associated target latency.

A subset of output devices requiring stricter synchronization may be identified. The subset of output devices may be associated with a sports betting application. A more precise target latency may be determined for the identified subset of output devices.

The first computing device may be implemented as a distributed system across multiple servers. Target latency determinations and output device groupings (assignments, etc.) may be coordinated across the multiple servers.

An indication of an adjustment to an output speed of the content may be received from the at least one output device based on the target latency. The first computing device may be part of a content delivery network (CDN). The content may be distributed through the CDN based on the determined target latencies.

Although example blocks are shown, some implementations may include additional blocks, fewer blocks, different blocks, or differently arranged blocks than those depicted. Additionally, or alternatively, two or more of the blocks may be performed in parallel.

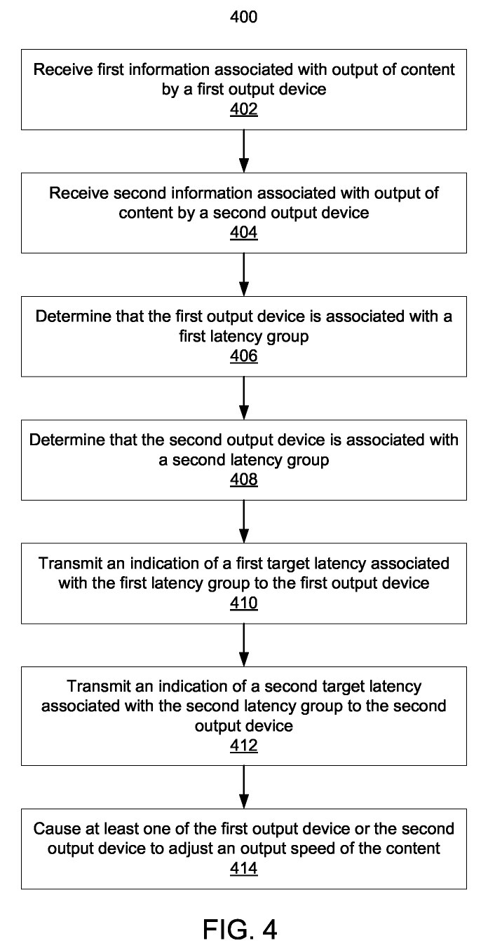

FIG. 4 illustrates a flowchart of a method 400 for synchronizing content output across multiple output devices. The method 400 may be performed by a computing device. The method 400 may be performed by the controller 110 in FIG. 1. The method 400 may be performed by the central server 230 in FIG. 2.

First information associated with output of content by a first ouput device may be received (block 402). The first information may be received by a first computing device. The first computing device may be the controller 110 in FIG. 1, or the central server 230 in FIG. 2, for example. The first information associated with output of content may include a current live latency, a wall clock time, an arrival time, a media/content decoding time, a time a segment became available at an origin server, a current rebuffering rate, an output rate, statistics of an observed network connection, or information associated with a content delivery network (CDN). The content may comprise a live video stream.

Second information associated with output of the content by a second output device may be received (block 404). The second information may be received by the first computing device. The second information associated with output of content may include a current live latency, a wall clock time, an arrival time, a media/content decoding time, a time a segment became available at an origin server, a current rebuffering rate, an output rate, statistics of an observed network connection, or information associated with a content delivery network (CDN).

The first output device may be determined to be associated with a first latency group (block 406). The determining that the first output device is associated with the first latency group may be based on the first information. The first information may comprise first parameters associated with the first output device. The first information may comprise a network condition. The network condition may comprise at least one of network bandwidth, network stability, or network latency. The first information may comprise a health metric. The health metric may comprise at least one of rebuffering rate, an output stability measure, or a network connection quality indicator. The first latency group may comprise a low-latency group.

The second output device may be determined to be associated with a second latency group (block 408). The determining that the second output device is associated with the second latency group may be based on the second information. The second information may comprise second parameters associated with the second output device. The second information may comprise a network condition. The network condition may comprise at least one of network bandwidth, network stability, or network latency. The second information may comprise a health metric. The health metric may comprise at least one of rebuffering rate, an output stability measure, or a network connection quality indicator. The second latency group may comprise a normal-latency group.

An indication of a first target latency associated with the first latency group may be transmitted to the first output device (block 410). The transmitting the indication of the first target latency associated with the first latency group to the first output device may comprise sending the indication of the target latency in a header of a response to a request from the first output device. The transmitting the indication of the first target latency associated with the first latency group to the first output device may comprise sending the indication of the target latency in a message separate from a response to a request from the first output device.

An indication of a second target latency associated with the second latency group may be transmitted to the second output device (block 412). The transmitting the indication of the second target latency associated with the second latency group to the second output device may comprise sending the indication of the target latency in a header of a response to a request from the second output device. The transmitting the indication of the second target latency associated with the second latency group to the second output device may comprise sending the indication of the target latency in a message separate from a response to a request from the second output device.

At least one of the first output device or the second output device may be caused to adjust an output speed of the content (block 414). Causing the first output device to adjust an output speed of the content may be based on the indication of the first target latency. Causing the second output device to adjust an output speed of the content may be based on the indication of the second target latency. At least one of the first output device or the second output device may adjust the output speed of the content by modifying a rendering time of one or more individual frames of the content.

An indication of an adjustment to an output speed of the content based on the first target latency may be received from the first output device. An indication of an adjustment to an output speed of the content based on the second target latency may be received from the second output device. The first output device may be reassigned to the second latency group based on a change in at least one parameter associated with the first output device. The change in parameters associated with the first output device may comprise a change in at least one network condition associated with the first output device. The change in parameters associated with the first output device may comprise a change in at least one health metric associated with the first output device. The first target latency may be determined (calculated, etc.) to minimize rebuffering events for output devices in the first latency group. Feedback may be received from the first output device regarding the first target latency. The first target latency may be adjusted to a third target latency associated with the first latency group based on the received feedback. An indication of the third target latency may be transmitted to the first output device.

Although example blocks are shown, some implementations may include additional blocks, fewer blocks, different blocks, or differently arranged blocks than those depicted. Additionally, or alternatively, two or more of the blocks may be performed in parallel.

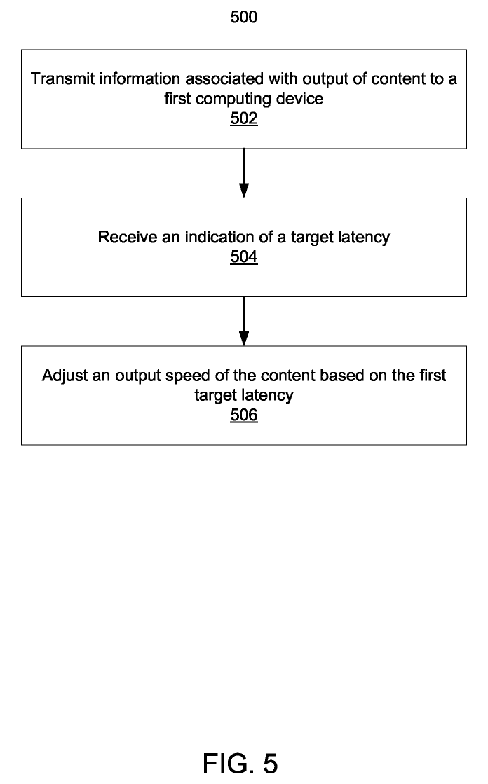

FIG. 5 illustrates a flowchart of a method 500 for synchronizing content output across multiple output devices. The method 500 may be performed by an output device. The method 500 may be performed by the client device 120 in FIG. 1. The method 500 may be performed by one or more of the display devices 212, 214, 222, 224 in FIG. 2.

Information associated with output of content may be transmitted to a first computing device (block 502). The information may be transmitted from an output device. The output device may be the client device 120 in FIG. 1, or one or more of the display devices 212, 214, 222, 224 in FIG. 2, for example. The information associated with output of the content may comprise at least one of a current live latency, a wall clock time, an arrival time, a media/content decoding time, a time a segment became available at an origin server, a current rebuffering rate, an output rate, statistics of an observed network connection, or information associated with a content delivery network (CDN).

An indication of a target latency may be received (block 504). The indication of the target latency may be received at the output device. The indication of the target latency may be received from the first computing device. The target latency may be associated with a first latency group. A determination to transmit the indication of the target latency may be based on the information. The information may comprise one or more parameters associated with the output device. The first computing device may make the determination to transmit the indication of the target latency. The information may comprise a network condition associated with the output device. The network condition may comprise at least one of network bandwidth, network stability, or network latency. The information may comprise a health metric of the output device. The health metric may comprise at least one of a rebuffering rate, an output stability measure, or a network connection quality indicator. The receiving the indication of the target latency may comprise separate target latencies for audio and video components of the content.

An output speed of the content may be adjusted based on the target latency (block 506). The adjusting the output of the content based on the target latency may comprise making small changes to individual frame rendering times to reach the target latency within a predetermined time period. The predetermined time period may be between 2 and 4 seconds. The adjusting the output speed of the content based on the target latency may comprise modifying the output speed within a range that maintains audio pitch. The adjusting the output speed of the content based on the target latency may comprise adjusting output speeds of the audio and video components independently based on respective target latencies.

Second information associated with output of the content may be transmitted to the first computing device . The second information may be transmitted from the output device. The second information may comprise one or more parameters associated with the output device. The second information associated with output of the content may comprise at least one of a current live latency, a wall clock time, an arrival time, a media/content decoding time, a time a segment became available at an origin server, a current rebuffering rate, an output rate, statistics of an observed network connection, or information associated with a content delivery network (CDN). The second information associated with output of the content may comprise output conditions associated with presentation of the content based on the target latency. The output conditions may comprise at least one of buffer fullness, frame drop rate, or audio-video synchronization status.

An indication of a second target latency may be received. The indication of the second target latency may be received at the output device. The indication of the second target latency may be received from the first computing device. The second target latency may be associated with a second latency group. A determination to transmit the indication of the second target latency may be based on the second information. The first computing device may make the determination to transmit the indication of the second target latency. The second information may comprise a network condition associated with the output device. The network condition may comprise at least one of network bandwidth, network stability, or network latency. The second information comprises a health metric of the output device. The health metric may comprise at least one of a rebuffering rate, an output stability measure, or a network connection quality indicator. The receiving the indication of the second target latency may comprise separate target latencies for audio and video components of the content.

The output speed of the content may be adjusted based on the second target latency. The adjusting the output of the content based on the second target latency may comprise making small changes to individual frame rendering times to reach the second target latency within a predetermined time period. The predetermined time period may be between 2 and 4 seconds. The adjusting the output speed of the content based on the second target latency may comprise modifying the output speed within a range that maintains audio pitch. The adjusting the output speed of the content based on the second target latency may comprise adjusting output speeds of the audio and video components independently based on respective target latencies.

Although example blocks are shown, some implementations may include additional blocks, fewer blocks, different blocks, or differently arranged blocks than those depicted. Additionally, or alternatively, two or more of the blocks may be performed in parallel.

### First Examples

Example Clause 1: A method comprising: receiving, by a first computing device, information associated with output of content by a plurality of output devices, the plurality of output devices comprising a plurality of first output devices and a plurality of second output devices; assigning the plurality of first output devices into a first latency group and the plurality of second output devices into a second latency group based on the information; determining a target latency for each latency group; transmitting, by the first computing device to at least one output device of the plurality of output devices, an indication of the target latency corresponding to a latency group of the at least one output device; and causing, based on the indication of the target latency, the at least one output device to adjust an output speed of the content by modifying a rendering time of one or more individual frames of the content.

Example Clause 2: The method of Example Clause 1, wherein the determining the target latency for each latency group comprises estimating a latency sufficient to maintain a predetermined percentage of output devices within each latency group within a selected latency range.

Example Clause 3: The method of Example Clause 1 or Example Clause 2, further comprising excluding, from the determining, information associated with output devices having latencies that differ from an estimated latency by more than a threshold amount.

Example Clause 4: The method of any one of Example Clauses 1-3, wherein transmitting the indication of the target latency comprises sending the indication of the target latency in a header of a response to a request from the at least one output device.

Example Clause 5: The method of any one of Example Clauses 1-4, wherein transmitting the indication of the target latency comprises sending the indication of the target latency in a message separate from a response to a request from the at least one output device.

Example Clause 6: The method of any one of Example Clauses 1-5, further comprising periodically recalculating the target latency for each latency group based on updated information received from the plurality of output devices.

Example Clause 7: The method of any one of Example Clauses 1-6, wherein the determining the target latency for each latency group comprises applying a statistical processing technique to the information associated with the output of the content for output devices within each latency group.

Example Clause 8: The method of any one of Example Clauses 1-7, wherein the statistical processing technique comprises at least one of: simple averaging, harmonic averaging, or a complex statistical signal processing technique.

Example Clause 9: The method of any one of Example Clauses 1-8, further comprising: determining a health metric for each output device based on the information; and using the health metric in the assigning the plurality of first output devices into the first latency group and the plurality of second output devices into the second latency group based on the information.

Example Clause 10: The method of any one of Example Clauses 1-9, wherein the target latency corresponding to the latency group is determined to reduce rebuffering events for output devices within the latency group.

Example Clause 11: The method of any one of Example Clauses 1-10, further comprising adjusting the target latency for a latency group based on a predetermined latency range associated with human perception of audio-visual synchronization.

Example Clause 12: The method of any one of Example Clauses 1-11, further comprising: monitoring changes in network topology affecting the plurality of output devices; and adjusting the assigning of output devices into latency groups based on the monitored changes.

Example Clause 13: The method of any one of Example Clauses 1-12, wherein the content comprises a live video stream, and the method further comprises dynamically adjusting the target latency for each latency group during the live video stream based on changing network conditions.

Example Clause 14: The method of any one of Example Clauses 1-13, wherein the assigning the plurality of first output devices into the first latency group and the plurality of second output devices into the second latency group based on the information is performed separately for audio and video components of the content.

Example Clause 15: The method of any one of Example Clauses 1-14, wherein the determining the target latency for each latency group is performed separately for audio and video components of the content.

Example Clause 16: The method of any one of Example Clauses 1-15, further comprising: identifying a subset of output devices requiring stricter synchronization; and determining a more precise target latency for the identified subset of the plurality of output devices.

Example Clause 17: A method comprising: receiving, by a first computing device, first information associated with output of content by a first output device; receiving, by the first computing device, second information associated with output of the content by a second output device; determining, based on the first information, that the first output device is associated with a first latency group; determining, based on the second information, that the second output device is associated with a second latency group; transmitting an indication of a first target latency associated with the first latency group to the first output device; transmitting an indication of a second target latency associated with the second latency group to the second output device; and causing, based on at least one of the indication of the first target latency or the indication of the second target latency, at least one of the first output device or the second output device to adjust an output speed of the content by modifying a rendering time of one or more individual frames of the content.

Example Clause 18: The method of Example Clause 17, wherein the first latency group comprises a low-latency group, wherein the second latency group comprises a normal-latency group, and further comprising reassigning the first output device to the second latency group based on a change in at least one parameter associated with the first output device.

Example Clause 19: A method comprising: transmitting, from an output device, information associated with output of content to a first computing device; receiving, at the output device, an indication of a target latency; and adjusting an output speed of the content based on the target latency by modifying a rendering time of one or more individual frames of the content.

Example Clause 20: The method of Example Clause 19, further comprising: transmitting, from the output device, second information associated with the output of the content to the first computing device; receiving, at the output device, an indication of a second target latency; and adjusting the output speed of the content based on the second target latency by modifying the rendering time of one or more individual frames of the content.

### Second Examples

Example Clause 1: A method comprising: receiving, by a controller, information associated with output of content by a plurality of client devices; assigning the plurality of client devices into at least two latency groups based on the information; determining a target latency for each latency group; and transmitting, by the controller to at least one client device of the plurality of client devices, an indication of a target latency corresponding to a latency group of the at least one client device.

Example Clause 2: The method of Example Clause 1, wherein the information associated with output of content comprises at least one of: a current live latency, a wall clock time, an arrival time, a media/content decoding time, a time a segment became available at an origin server, a current rebuffering rate, an output rate, statistics of an observed network connection, or information associated with a content delivery network (CDN).

Example Clause 3: The method of Example Clause 1 or Example Clause 2, wherein the assigning the plurality of client devices into the at least two latency groups comprises: analyzing network conditions associated with each client device; and assigning each client device to a latency group based on the analyzed network conditions.

Example Clause 4: The method of any one of Example Clauses 1-3, wherein the information comprises at least one of: network bandwidth, network stability, or network latency.

Example Clause 5: The method of any one of Example Clauses 1-4, wherein the determining the target latency for each latency group comprises estimating a latency sufficient to maintain a predetermined percentage of client devices within each latency group within a selected latency range.

Example Clause 6: The method of any one of Example Clauses 1-5, further comprising excluding, from the determining, information associated with client devices having latencies that differ from an estimated latency by more than a threshold amount.

Example Clause 7: The method of any one of Example Clauses 1-6, wherein transmitting the indication of the target latency comprises sending the indication of the target latency in a header of a response to a request from the at least one client device.

Example Clause 8: The method of any one of Example Clauses 1-7, wherein transmitting the indication of the target latency comprises sending the indication of the target latency in a message separate from a response to a request from the at least one client device.

Example Clause 9: The method of any one of Example Clauses 1-8, further comprising receiving, from the at least one client device, an indication of an adjustment to an output speed of the content based on the target latency.

Example Clause 10: The method of any one of Example Clauses 1-9, wherein the at least two latency groups comprise a low-latency group and a normal-latency group.

Example Clause 11: The method of any one of Example Clauses 1-10, further comprising reassigning a client device from the low-latency group to the normal-latency group based on a change in network conditions associated with the client device.

Example Clause 12: The method of any one of Example Clauses 1-11, further comprising notifying the reassigned client device of the change from a low-latency experience to a normal-latency experience.

Example Clause 13: The method of any one of Example Clauses 1-12, further comprising periodically recalculating the target latency for each latency group based on updated information received from the plurality of client devices.

Example Clause 14: The method of any one of Example Clauses 1-13, wherein the determining the target latency for each latency group comprises applying a statistical processing technique to the information associated with output of content for client devices within each latency group.

Example Clause 15: The method of any one of Example Clauses 1-14, wherein the statistical processing technique comprises at least one of: simple averaging, harmonic averaging, or a complex statistical signal processing technique.

Example Clause 16: The method of any one of Example Clauses 1-15, further comprising: determining a health metric for each client device based on the information; and using the health metric in the assigning of the plurality of client devices into the at least two latency groups.

Example Clause 17: The method of any one of Example Clauses 1-16, wherein the information comprises at least one of: a rebuffering rate, an output stability measure, or a network connection quality indicator.

Example Clause 18: The method of any one of Example Clauses 1-17, wherein the target latency corresponding to the latency group is determined to reduce rebuffering events for client devices within the latency group.

Example Clause 19: The method of any one of Example Clauses 1-18, further comprising adjusting the target latency for a latency group based on a predetermined latency range associated with human perception of audio-visual synchronization.

Example Clause 20: The method of any one of Example Clauses 1-19, wherein the predetermined latency range is between -125 milliseconds and +45 milliseconds.

Example Clause 21: The method of any one of Example Clauses 1-20, further comprising: monitoring changes in network topology affecting the plurality of client devices; and adjusting the assigning of client devices into latency groups based on the monitored changes.

Example Clause 22: The method of any one of Example Clauses 1-21, wherein the content comprises a live video stream, and the method further comprises dynamically adjusting the target latency for each latency group during the live video stream based on changing network conditions.

Example Clause 23: The method of any one of Example Clauses 1-22, further comprising: receiving feedback from the at least one client device regarding the target latency; and adjusting subsequent target latency determinations based on the received feedback.

Example Clause 24: The method of any one of Example Clauses 1-23, wherein the assigning the plurality of client devices into the at least two latency groups is performed for a video component of the content.

Example Clause 25: The method of any one of Example Clauses 1-24, wherein the assigning the plurality of client devices into the at least two latency groups is performed separately for audio and video components of the content.

Example Clause 26: The method of any one of Example Clauses 1-25, wherein the determining the target latency for each latency group is performed for a video component of the content.

Example Clause 27: The method of any one of Example Clauses 1-26, wherein the determining the target latency for each latency group is performed separately for audio and video components of the content.

Example Clause 28: The method of any one of Example Clauses 1-27, further comprising: identifying a subset of client devices requiring stricter synchronization; and determining a more precise target latency for the identified subset of the plurality of client devices.

Example Clause 29: A method comprising: receiving, by a controller, first information associated with output of content by a first client device; receiving, by the controller, second information associated with output of the content by a second client device; determining, based on the first information, that the first client device is associated with a first latency group; determining, based on the second information, that the second client device is associated with a second latency group; transmitting an indication of a first target latency associated with the first latency group to the first client device; and transmitting an indication of a second target latency associated with the second latency group to the second client device.

Example Clause 30: The method of Example Clause 29, wherein at least one of the first information associated with output of the content and the second information associated with output of the content comprises at least one of: a current live latency, a wall clock time, an arrival time, a media/content decoding time, a time a segment became available at an origin server, a current rebuffering rate, an output rate, statistics of an observed network connection, or information associated with a content delivery network (CDN).

Example Clause 31: The method of Example Clause 29 or Example Clause 30, wherein at least one of the first information and the second information comprises a network condition.

Example Clause 32: The method of any one of Example Clauses 29-31, wherein the network condition comprises at least one of network bandwidth, network stability, or network latency.

Example Clause 33: The method of any one of Example Clauses 29-32, wherein the transmitting the indication of the first target latency associated with the first latency group to the first client device comprises sending the indication of the target latency in a header of a response to a request from the first client device.

Example Clause 34: The method of any one of Example Clauses 29-33, wherein the transmitting the indication of the second target latency associated with the second latency group to the second client device comprises sending the indication of the target latency in a header of a response to a request from the second client device.

Example Clause 35: The method of any one of Example Clauses 29-34, wherein the transmitting the indication of the first target latency associated with the first latency group to the first client device comprises sending the indication of the target latency in a message separate from a response to a request from the first client device.

Example Clause 36: The method of any one of Example Clauses 29-35, wherein the transmitting the indication of the second target latency associated with the second latency group to the second client device comprises sending the indication of the target latency in a message separate from a response to a request from the second client device.

Example Clause 37: The method of any one of Example Clauses 29-36, further comprising receiving, from at least one of the first client device and the second client device, an indication of an adjustment to an output speed of the content based on at least one of the first target latency and the second target latency.

Example Clause 38: The method of any one of Example Clauses 29-37, wherein the first latency group comprises a low-latency group.

Example Clause 39: The method of any one of Example Clauses 29-38, wherein the second latency group comprises a normal-latency group.

Example Clause 40: The method of any one of Example Clauses 29-39, further comprising reassigning the first client device to the second latency group based on a change in at least one parameter associated with the first client device.

Example Clause 41: The method of any one of Example Clauses 29-40, wherein the change in at least one parameter associated with the first client device comprises a change in at least one network condition associated with the first client device.

Example Clause 42: The method of any one of Example Clauses 29-41, wherein the change in at least one parameter associated with the first client device comprises a change in at least one a health metric associated with the first client device.

Example Clause 43: The method of any one of Example Clauses 29-42, wherein at least one of the first information and the second information comprises a health metric.

Example Clause 44: The method of any one of Example Clauses 29-43, wherein the health metric comprises at least one of a rebuffering rate, an output stability measure, or a network connection quality indicator.

Example Clause 45: The method of any one of Example Clauses 29-44, wherein the first target latency is determined to minimize rebuffering events for client devices in the first latency group.

Example Clause 46: The method of any one of Example Clauses 29-45, further comprising: receiving feedback from the first client device regarding the first target latency; adjusting the first target latency to a third target latency associated with the first latency group based on the received feedback; and transmitting an indication of the third target latency to the first client device.

Example Clause 47: A method comprising: transmitting, from a client device, first information associated with output of content to a controller; receiving, at the client device, an indication of a first target latency; adjusting an output speed of the content based on the first target latency; transmitting, from the client device, second information associated with output of the content to the controller; receiving, at the client device, an indication of a second target latency; and adjusting the output speed of the content based on the second target latency.

Example Clause 48: The method of Example Clause 47, wherein at least one of the first information associated with output of the content and the second information associated with output of the content comprises at least one of: a current live latency, a wall clock time, an arrival time, a media/content decoding time, a time a segment became available at an origin server, a current rebuffering rate, an output rate, statistics of an observed network connection, or information associated with a content delivery network (CDN).

Example Clause 49: The method of Example Clause 47 or Example Clause 48, wherein the adjusting the output of the content based on the first target latency comprises making small changes to individual frame rendering times to reach the first target latency within a predetermined time period.

Example Clause 50: The method of any one of Example Clauses 47-49, wherein the predetermined time period is between 2 and 4 seconds.

Example Clause 51: The method of any one of Example Clauses 47-50, wherein the adjusting the output of the content based on the second target latency comprises making small changes to individual frame rendering times to reach the second target latency within a predetermined time period.

Example Clause 52: The method of any one of Example Clauses 47-51, wherein the predetermined time period is between 2 and 4 seconds.

Example Clause 53: The method of any one of Example Clauses 47-52, wherein the first target latency is associated with a first latency group and wherein the second target latency is associated with a second latency group.

Example Clause 54: The method of any one of Example Clauses 47-53, wherein at least one of a determination to transmit the indication of the first target latency and a determination to transmit the indication of the second target latency is based on parameters associated with the client device.

Example Clause 55: The method of any one of Example Clauses 47-54, wherein the parameters comprise a network condition associated with the client device.

Example Clause 56: The method of any one of Example Clauses 47-55, wherein the network condition comprises at least one of network bandwidth, network stability, or network latency.

Example Clause 57: The method of any one of Example Clauses 47-56, wherein the parameters comprise a health metric of the client device.

Example Clause 58: The method of any one of Example Clauses 47-57, wherein the health metric comprises at least one of a rebuffering rate, an output stability measure, or a network connection quality indicator.

Example Clause 59: The method of any one of Example Clauses 47-58, wherein the second information associated with output of the content comprises output conditions associated with presentation of the content based on the first target latency.

Example Clause 60: The method of any one of Example Clauses 47-59, wherein the output conditions comprise at least one of buffer fullness, frame drop rate, or audio-video synchronization status.

Example Clause 61: The method of any one of Example Clauses 47-60, wherein at least one of the adjusting the output speed of the content based on the first target latency and the adjusting the output speed of the content based on the second target latency comprises modifying the output speed within a range that maintains audio pitch.

Example Clause 62: The method of any one of Example Clauses 47-61, wherein at least one of the receiving the indication of the first target latency and the receiving the indication of the second target latency comprises separate target latencies for audio and video components of the content.

Example Clause 63: The method of any one of Example Clauses 47-62 wherein at least one of the adjusting the output speed of the content based on the first target latency and the adjusting the output speed of the content based on the second target latency comprises adjusting output speeds of the audio and video components independently based on respective target latencies.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, by a first computing device, information associated with output of content by a plurality of output devices, the plurality of output devices comprising a plurality of first output devices and a plurality of second output devices, wherein the plurality of first output devices are associated with a first latency group and the plurality of second output devices are associated with a second latency group based on at least the information;
determining a target latency for at least the first latency group and the second latency group;
transmitting, by the first computing device to at least one output device of the plurality of output devices, an indication of the target latency corresponding to a latency group of the at least one output device; and
causing, based on the indication of the target latency, the at least one output device to adjust an output speed of the content by modifying a rendering time of one or more individual frames of the content.

2. The method of claim 1, wherein the determining the target latency for each latency group comprises estimating a latency sufficient to maintain a predetermined percentage of output devices within each latency group within a selected latency range.

3. The method of claim 2, further comprising excluding, from the determining, information associated with output devices having latencies that differ from an estimated latency by more than a threshold amount.

4. The method of claim 1, wherein transmitting the indication of the target latency comprises sending the indication of the target latency in a header of a response to a request from the at least one output device.

5. The method of claim 1, wherein transmitting the indication of the target latency comprises sending the indication of the target latency in a message separate from a response to a request from the at least one output device.

6. The method of claim 1, further comprising periodically recalculating the target latency for each latency group based on updated information received from the plurality of output devices.

7. The method of claim 1, wherein the determining the target latency for each latency group comprises applying a statistical processing technique to the information associated with the output of the content for output devices within each latency group.

8. The method of claim 7, wherein the statistical processing technique comprises at least one of: simple averaging, harmonic averaging, or a complex statistical signal processing technique.

9. The method of claim 1, further comprising:
determining a health metric for one or more output device based on the information, wherein the association of the plurality of first output devices with the first latency group and the association of the plurality of second output devices with the second latency group is based at least on the health metric.

10. The method of claim 1, wherein the target latency corresponding to the latency group is determined to reduce rebuffering events for output devices within the latency group.

11. The method of claim 1, further comprising adjusting the target latency for a latency group based on a predetermined latency range associated with human perception of audio-visual synchronization.

12. The method of claim 1, further comprising:
monitoring changes in network topology affecting the plurality of output devices; and
adjusting the association of output devices into latency groups based on the monitored changes.

13. The method of claim 1, wherein the content comprises a live video stream, and the method further comprises dynamically adjusting the target latency for each latency group during the live video stream based on changing network conditions.

14. The method of claim 1, wherein the determining the target latency for each latency group is performed separately for audio and video components of the content.

15. The method of claim 1, further comprising:
identifying a subset of output devices requiring stricter synchronization; and
determining a more precise target latency for the identified subset of the plurality of output devices.

16. A method comprising:
receiving, by a first computing device, first information associated with output of content by a first output device;
receiving, by the first computing device, second information associated with output of the content by a second output device;
determining, based on the first information, that the first output device is associated with a first latency group;
determining, based on the second information, that the second output device is associated with a second latency group;
transmitting an indication of a first target latency associated with the first latency group to the first output device;
transmitting an indication of a second target latency associated with the second latency group to the second output device; and
causing, based on at least one of the indication of the first target latency or the indication of the second target latency, at least one of the first output device or the second output device to adjust an output speed of the content by modifying a rendering time of one or more individual frames of the content.

17. The method of claim 16, wherein the first latency group comprises a low-latency group, wherein the second latency group comprises a normal-latency group, and further comprising reassigning the first output device to the second latency group based on a change in at least one parameter associated with the first output device.

18. The method of claim 16, wherein one or more of the determining the first output device is associated with the first latency group and the determining the second output device is associated with the second latency group is performed separately for audio and video components of the content.

19. A method comprising:
transmitting, from an output device, information associated with output of content to a first computing device;
receiving, at the output device, an indication of a target latency; and
adjusting an output speed of the content based on the target latency by modifying a rendering time of one or more individual frames of the content.

20. The method of claim 19, further comprising:
transmitting, from the output device, second information associated with the output of the content to the first computing device;
receiving, at the output device, an indication of a second target latency; and
adjusting the output speed of the content based on the second target latency by modifying the rendering time of one or more individual frames of the content.
